(19) United States
(12) Patent Application Publication
(10) Pub. No.: US 2024/0192006 A1
(43) Pub. Date: Jun. 13, 2024

(54) REAL-TIME NAVIGATION ROUTE AIDING POSITIONING ENGINE

(71) Applicant: QUALCOMM Incorporated, San Diego, CA (US)

(72) Inventors: Yuxiang PENG, Sunnyvale, CA (US); Ning LUO, Cupertino, CA (US); Min WANG, Tustin, CA (US)

(21) Appl. No.: 18/063,435

(22) Filed: Dec. 8, 2022

(51) Int. Cl. G01C 21/34; G01C 21/30; G01S 19/07; H04W 4/024

(52) U.S. Cl. CPC G01C 21/3492; G01C 21/30; G01S 19/07; H04W 4/024

(57) ABSTRACT

Aspects presented herein may enable a navigation application of a UE to feed its calculated navigation route information to a PE of the UE to aid the PE computing positioning estimations to improve positioning accuracy. In one aspect, a UE estimates a current location of the UE based on a set of positioning measurements and time update predictions using a positioning engine. The UE calculates real-time navigation route information using at least one navigation application based on the current location of the UE, a destination of the UE, and map information. The UE changes or verifies a set of positioning estimations performed by the positioning engine based on the real-time navigation route information from the at least one navigation application.

### TECHNICAL FIELD

The present disclosure relates generally to communication systems, and more particularly, to a wireless communication involving positioning.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus estimates a current location of a user equipment (UE) based on a set of positioning measurements and time update predictions using a positioning engine. The apparatus calculates real-time navigation route information using at least one navigation application based on the current location of the UE, a destination of the UE, and map information. The apparatus changes or verifies a set of positioning estimations performed by the positioning engine based on the real-time navigation route information from the at least one navigation application.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of Global Navigation Satellite System (GNSS) positioning in accordance with various aspects of the present disclosure.

FIG. 6 is a diagram illustrating an example of a navigation application in accordance with various aspects of the present disclosure.

FIG. 7 is a diagram illustrating an example of a navigation application in accordance with various aspects of the present disclosure.

FIG. 8 is a diagram illustrating an example close-loop configuration for a positioning engine and a navigation application in accordance with various aspects of the present disclosure.

FIG. 9 is a flowchart illustrating an example algorithm that enables a UE to switch between the open-loop configuration and the closed-loop configuration in accordance with various aspects of the present disclosure.

FIG. 10 is a diagram illustrating an example accuracy comparison between the open-loop configuration and the closed-loop configuration in accordance with various aspects of the present disclosure.

FIG. 11 is a flowchart of a method of wireless communication.

FIG. 12 is a flowchart of a method of wireless communication.

FIG. 13 is a diagram illustrating an example of a hardware implementation for an apparatus or a network entity.

### DETAILED DESCRIPTION

Aspects presented herein may improve the performance and accuracy of a positioning engine (PE) by configuring the positioning engine to receive feedback from a navigation application. For example, in one aspect of the present disclosure, a navigation application may feed its calculated navigation route information to a positioning engine (PE) to aid the PE computing positioning estimations based on a Kalman filter (KF) process/algorithm. Then, these positioning estimations may be used by the navigation application for calculating future navigation route information or updating the navigation route information (e.g., for performing KF time update and KF measurement update associated with the KF process/algorithm). This process/call flow may continue to repeat between the PE and the navigation application to create a closed-loop configuration/solution. In some examples, for the KF time update, the navigation route information may serve as a more accurate dynamic model, and for the KF measurement update, the navigation route information may be used for measurement outlier detection (e.g., for detecting error measurements or measurements that exceed an error threshold).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

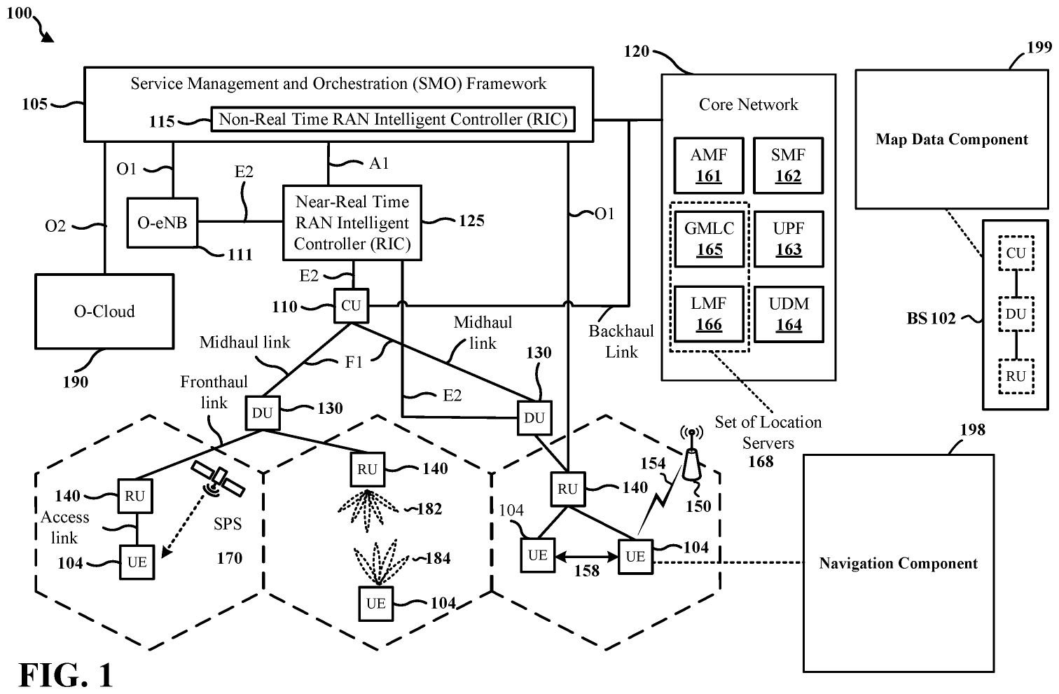

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (0-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz—7.125 GHz) and FR2 (24.25 GHz—52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz—300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz—24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz—71 GHz), FR4 (71 GHz—114.25 GHz), and FR5 (114.25 GHz—300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to estimate a current location of the UE based on a set of positioning measurements and time update predictions using a positioning engine; calculate real-time navigation route information using at least one navigation application based on the current location of the UE, a destination of the UE, and map information; and change or verify a set of positioning estimations performed by the positioning engine based on the real-time navigation route information from the at least one navigation application (e.g., via the navigation component 198). As further shown in FIG. 1, the base station 102 may include a map data component 199.

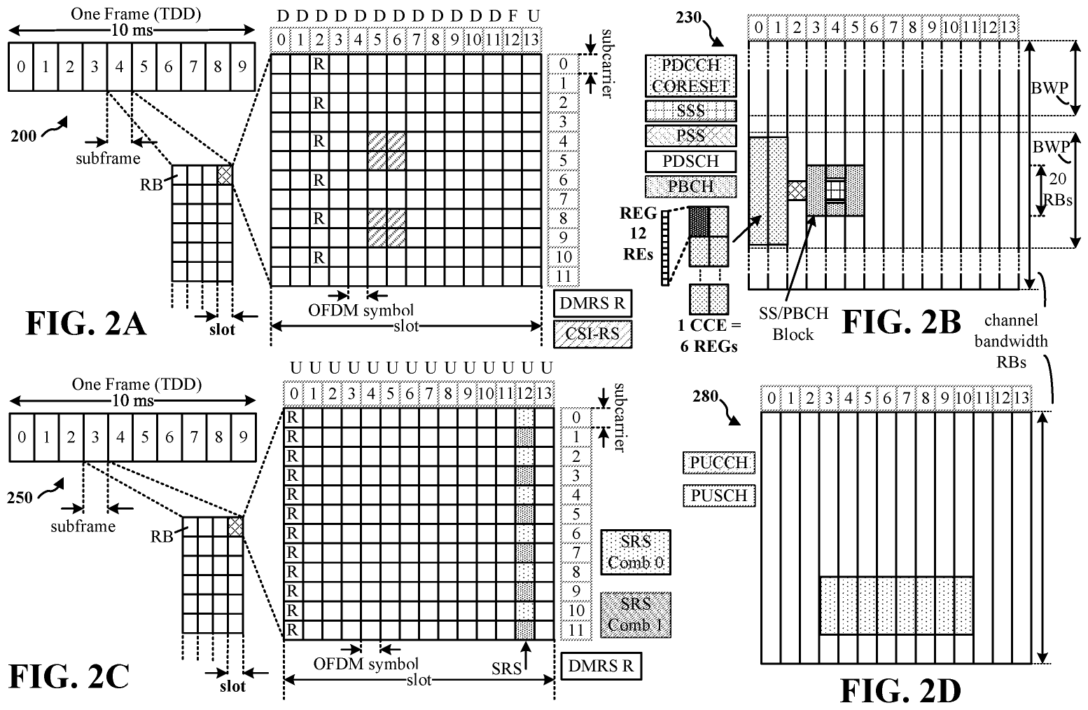

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology u=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

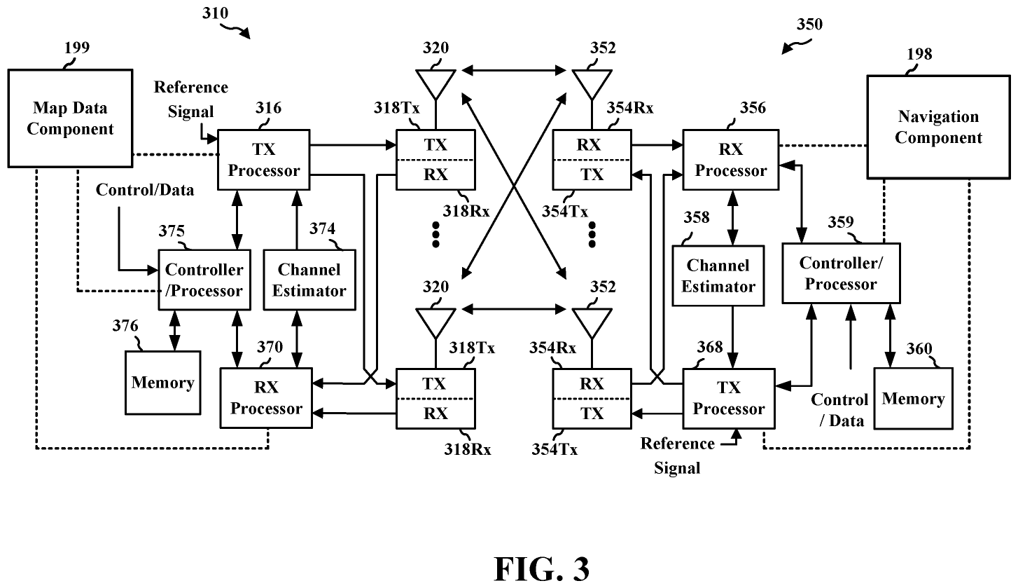

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the navigation component 198 of FIG. 1.

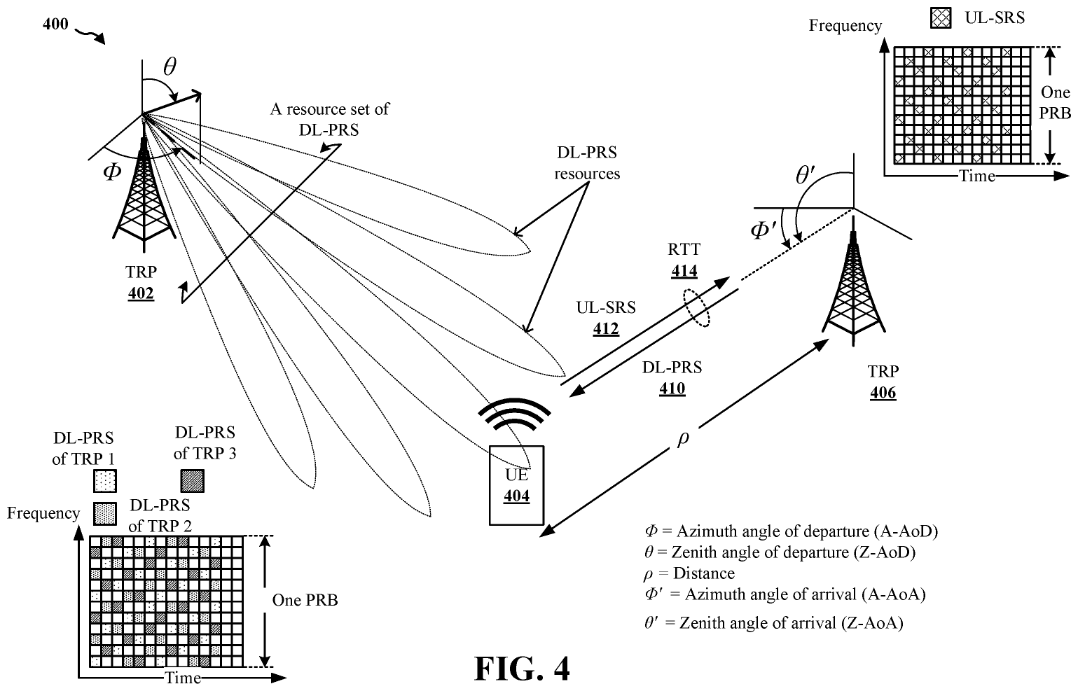

FIG. 4 is a diagram 400 illustrating an example of a UE positioning based on reference signal measurements (which may also be referred to as “network-based positioning”) in accordance with various aspects of the present disclosure. The UE 404 may transmit UL-SRS 412 at time T_{SRS_TX} and receive DL positioning reference signals (PRS) (DL-PRS) 410 at time T_{PRS_Rx}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s)168) or the UE 404 may determine the RTT 414 based on∥T_{SRS_Rx}—T_{PRS_TX}||T_{SRS_TX}−T_{PRS_RX}∥. Accordingly, multi-RTT positioning may make use of the UE Rx-Tx time difference measurements (i.e., |T_{SRS_TX}−T_{PRS_Rx}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information. For example, some UE positioning mechanisms may be radio access technology (RAT)-dependent (e.g., the positioning of a UE is based on a RAT), such as the downlink positioning (e.g., measuring of observed time difference of arrival (OTDOA), the uplink positioning (e.g., measuring of uplink time difference of arrival (UTDOA), and/or the combined DL and UL based positioning (e.g., measuring of RTT with respect to neighboring cells), etc. Some wireless communications systems may also support Enhanced Cell-ID (E-CID) positioning procedures that are based on radio resource management (RRM) measurements. On the other hand, some UE positioning mechanisms may be RAT-independent (e.g., the positioning of a UE does not rely on a RAT), such as the enhanced GNSS, and/or positioning technologies based on WLAN, Bluetooth, Terrestrial Beason System (TBS), and/or sensor based (e.g., barometric sensor, motion sensor), etc. Some UE positioning mechanisms may be based on a hybrid model, where multiple methods for positioning are used, which may include both RAT-dependent positioning technology and RAT-independent positioning technology (e.g., a GNSS with OTDOA hybrid positioning).

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

A device (e.g., a UE) equipped with a global navigation satellite system (GNSS) receiver (which may include the Global Positioning System (GPS) receiver) may determine its location based on GNSS positioning. GNSS is a network of satellites broadcasting timing and orbital information used for navigation and positioning measurements. GNSS may include multiple groups of satellites, known as constellations, that broadcast signals (which may be referred to as GNSS signals) to control stations and users of the GNSS. Based on the broadcast signals, the users may be able to determine their locations (e.g., via trilateration process). For purposes of the present disclosure, a device (e.g., a UE) that is equipped with a GNSS receiver or is capable of receiving GNSS signals may be referred to as a GNSS device, and a device that is capable of transmitting GNSS signals, such as a satellite, may be referred to as a space vehicle (SV).

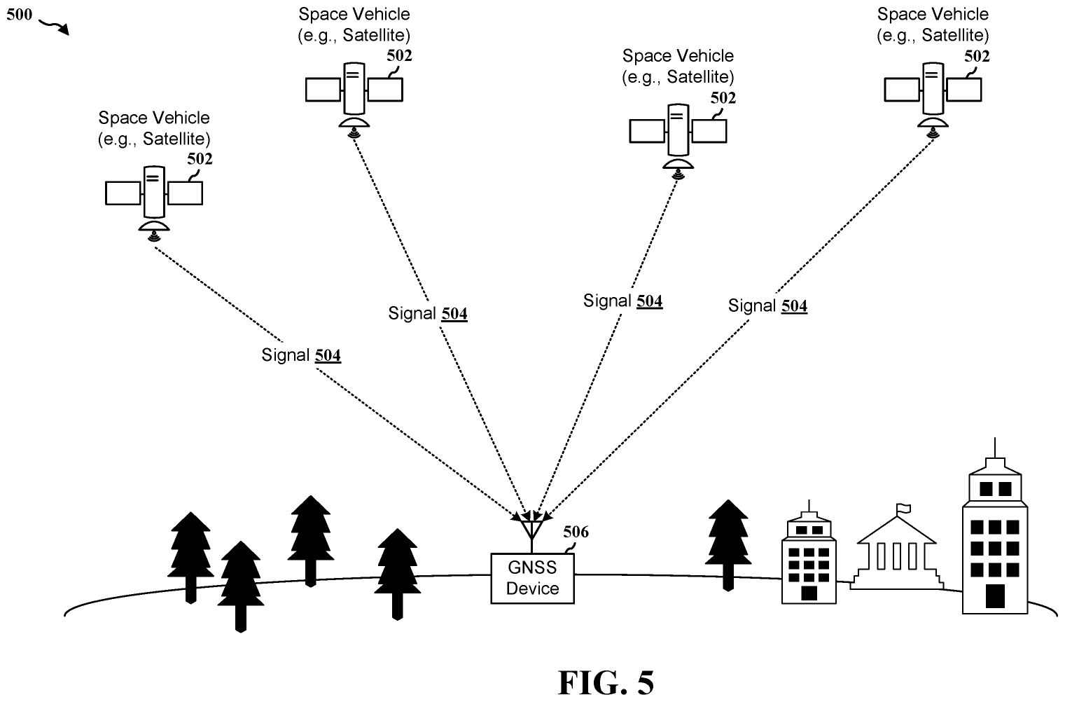

FIG. 5 is a diagram 500 illustrating an example of GNSS positioning in accordance with various aspects of the present disclosure. A GNSS device 506 may calculate its position and time based at least in part on data (e.g., GNSS signals 504) received from multiple space vehicles (SVs) 502, where each SV 502 may carry a record of its position and time and may transmit that data (e.g., the record) to the GNSS device 506. Each SV 502 may further include a clock that is synchronized with other clocks of SVs and with ground clock(s). If an SV 502 detects that there is a drift from the time maintained on the ground, the SV 502 may correct it. The GNSS device 506 may also include a clock, but the clock for the GNSS device 506 may be less stable and precise compared to the clocks for each SV 502.

As the speed of radio waves may be constant and independent of the satellite speed, a time delay between a time the SV 502 transmits a GNSS signal 504 and a time the GNSS device 506 receives the GNSS signal 504 may be proportional to the distance from the SV 502 to the GNSS device 506. In some examples, a minimum of four SVs may be used by the GNSS device 506 to compute/calculate one or more unknown quantities associated with positioning (e.g., three position coordinates and clock deviation from satellite time, etc.).

Each SV 502 may broadcast the GNSS signal 504 (e.g., a carrier wave with modulation) continuously that may include a pseudorandom code (e.g., a sequence of ones and zeros) which may be known to the GNSS device 506, and may also include a message that includes a time of transmission and the SV position at that time. In other words, each GNSS signal 504 may carry two types of information: time and carrier wave (e.g., a modulated waveform with an input signal to be electromagnetically transmitted). Based on the GNSS signals 504 received from each SV 502, the GNSS device 506 may measure the time of arrivals (TOAs) of the GNSS signals 504 and calculate the time of flights (TOFs) for the GNSS signals 504. Then, based on the TOFs, the GNSS device 506 may compute its three-dimensional position and clock deviation, and the GNSS device 506 may determine its position on the Earth. For example, the GNSS device 506's location may be converted to a latitude, a longitude, and a height relative to an ellipsoidal Earth model. These coordinates may be displayed, such as on a moving map display, or recorded or used by some other system, such as a vehicle guidance system.

While the distance between a GNSS device and an SV may be calculated based on the time it takes for a GNSS signal to reach the GNSS device, the SV's signal sequence may be delayed in relation to the GNSS device's sequence. Thus, in some examples, a delay may be applied to the GNSS device's sequence, such that the two sequences are aligned. For example, to calculate the delay, a GNSS device may align a pseudorandom binary sequence contained in the SV's signal to an internally generated pseudorandom binary sequence. As the SV's GNSS signal takes time to reach the GNSS device, the SV's sequence may be delayed in relation to the GNSS device's sequence. By increasingly delaying the GNSS device's sequence, the two sequences may eventually be aligned.

The accuracy of GNSS based positioning may depend on various factors, such as satellite geometry, signal blockage, atmospheric conditions, and/or receiver design features/quality, etc. For example, GNSS receivers used by smartphones or smart watches may have lower accuracy compared to GNSS receivers used by vehicles and surveying equipments.

In some examples, a software or an application that accepts positioning related measurements from GNSS chipsets and/or sensors to estimate position, velocity, and/or altitude of a device may be referred to as a positioning engine (PE). In addition, a positioning engine that is capable of achieving certain high level of accuracy (e.g., centimeter/decimeter level accuracy) and/or latency may be referred to as a precise positioning engine (PPE). On the other hand, a navigation application may refer to an application in a user equipment (e.g., a smartphone, an in-vehicle navigation system, a GPS device, etc.) that is capable of providing navigational directions in real time. Over the last few years, users have increasingly relied on navigation applications because they have provided various benefits. For example, navigation applications may provide convenience to users as they enable the users to find a way to their destinations, and also allow users to contribute information and mark places of importance thereby generating the most accurate description of a location. In some examples, navigation applications are also capable of providing expert guidance for users, where a navigation application may guide a user to a destination via the best, most direct, or most time-saving routes. For example, a navigation application may obtain the current status of traffic, and then locate a shortest and fastest way for a user to reach a destination, and also provide approximately how long it will take the user to reach the destination. As such, a navigation application may use an Internet connection and a GPS/GNSS navigation system to provide turn-by-turn guided instructions on how to arrive at a given destination.

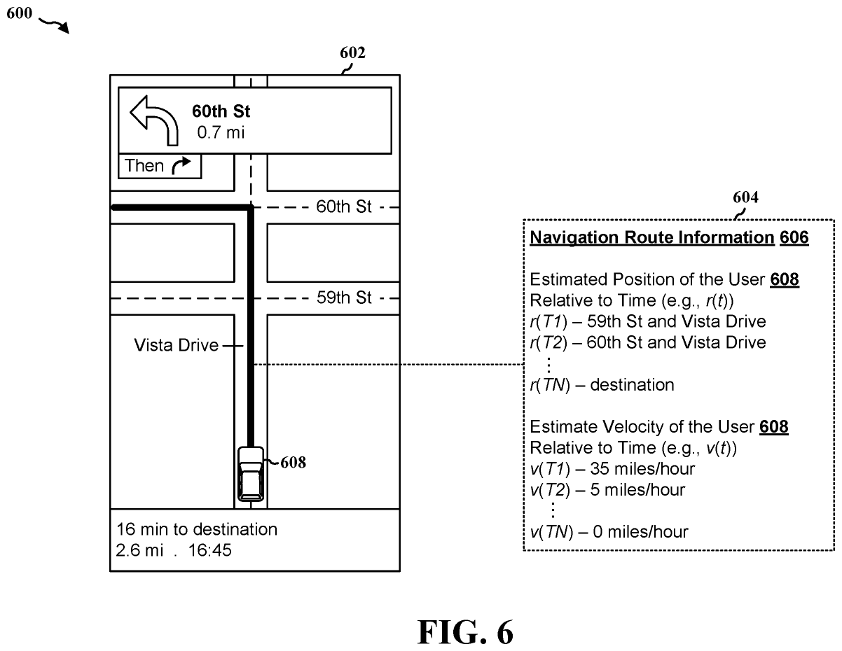

FIG. 6 is a diagram 600 illustrating an example of a navigation application in accordance with various aspects of the present disclosure. As shown at 602, a navigation application may provide a user (e.g., via a display or interface) with turn-by-turn directions to a destination and an estimated time to reach the destination based on real-time information. For example, the navigation application may receive/download real-time traffic information, road condition information, local traffic rules (e.g., speed limits), and/or map information/data from a server. Then, the navigation application may calculate a route to the destination based on at least the map information and other available information. The map information may include the map of the area in which the user is traveling, such as the streets, buildings, and/or terrains of the area, or a map that is compatible with the navigation application and GPS/GNSS system. In some examples, the route calculated by the navigation application may be the shortest or the fastest route. For purposes of the present disclosure, information associated with this calculated route may be referred to as navigation route information. For example, navigation route information may include predicted/estimated positions, velocities, accelerations, directions, and/or altitudes of the user at different points in time.

For example, as shown at 604, based on the map information, the speed limit, and the real-time road condition information, the navigation application may generate navigation route information 606 that guides a user 608 to a destination. In some examples, the navigation route information 606 may include the position of the user and velocity of the user relative/respect to time, which may be denoted as \vec{r}(t) and \vec{v}(t), respectively. For example, the navigation application may estimate that at a first point in time (T1), the user may reach a first point/place with certain speed (e.g., the intersection of 59th Street and Vista Drive with a velocity of 35 miles per hour), and at a second point in time (T2), the user may reach a second point/place with certain speed (e.g., the intersection of 60th Street and Vista Drive with a velocity of 15 miles per hour), and up to N^{th} point in time (TN), etc.

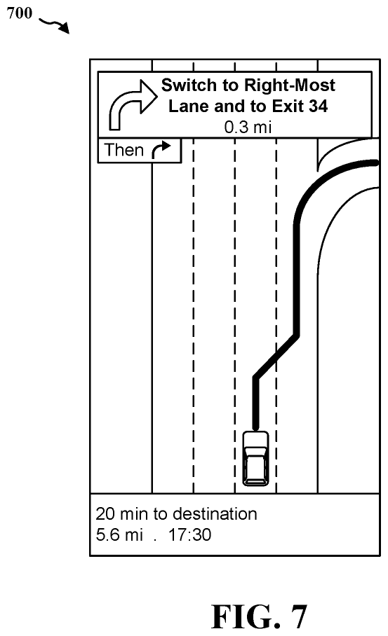

FIG. 7 is a diagram 700 illustrating an example of a navigation application in accordance with various aspects of the present disclosure. In some examples, as positioning and navigation technology using GNSS and maps (sometimes plus inertial measurement unit (IMU) and magnetometers) has become ubiquitous to people's daily life and enabled by various precise and robust positioning techniques, certain navigation application may have the capability to provide/achieve lane-level navigation which may offer users with much better navigation solutions at the application level. For example, when the user is driving on a highway, the navigation application may be able to determine a current lane in which a user is in, and the navigation application may notify the user to change to another lane if appropriate (e.g., if the current lane will lead the user to a wrong exit or miss an exit). However, to achieve such advanced navigation (e.g., lane-level navigation), an integration of precise state estimation, motion planning and HD map may be important for end-to-end navigation applications.

As described in connection with FIG. 6, application (AP) level navigation route information may provide a device's position relative to time \vec{r}(t) and velocity relative to time \vec{v}(t) information to some extend based on speed limit and/or real-time road condition/traffic information. With advanced/lane-level navigation, the uncertainty of these information (e.g., the level of uncertainty allowed) may be specified to be much smaller. For example, a general navigation application may specify a distance uncertainty to be plus/minus 5 meters and a velocity uncertainty of plus/minus 10 miles per hour, whereas an advanced/lane-level navigation application may specify a distance uncertainty to be plus/minus 1 meter and a velocity uncertainty of plus/minus 1 mile per hour, etc.

Some UEs (e.g., smartphones, in-vehicle navigation systems, GPS devices, etc.) may be configured to compute position estimates (e.g., current location of the UE) based on current measurements while some UEs may use both current measurements and a short history of immediate computed solutions and trajectory information. In addition, these UEs may use least square (LS) approximations or Kalman filters (KF) solutions in computing position estimates. A difference between an LS solution and a KF solution may reside in whether the UE uses previous user trajectory information. For example, a UE using an LS algorithm may calculate its position estimates based on measurements from current time epoch. On the other hand, a UE using a KF algorithm may combine measurements from the current time epoch with estimated previous UE behavior (e.g., trajectory, velocity, and acceleration). To avoid influencing a current position estimate with an uncorrelated distant position estimate, a UE may limit historical information to a window of time immediately preceding the current time and ignores old position estimates. Thus, the UE may use an immediate window of historical information but once used by the KF algorithm the UE may discard the historical information. A KF solution may rely on consecutively performed steps, namely the time update (which may also be referred to as the “time update prediction” or “KF time update”) and the measurement update (which may also be referred to as the “measurement update correction” or the “KF measurement update”). The time update may represent the propagation of unknown parameters (e.g., KF states to be estimated) with time and the measurement update may be responsible for the incorporation of new allocated measurements into the KF filter.

Most UEs (e.g., smartphones, in-vehicle navigation systems, GPS devices, etc.) may perform navigation calculation/estimation based on an open loop configuration. For example, a UE may measure its velocity, direction, and/or acceleration using an IMU sensor (via a measurement engine), and provide the measurements to a positioning engine. Then, the positioning engine may compute position estimates of the UE (which may also be referred to as “positioning estimations”) based on a KF process/algorithm and the measurements. A high-level operating system (HLOS) or an application (e.g., a navigation application) may use the position estimates from the positioning engine to perform other functions. For example, a navigation application may use the position estimates to perform map, motion, and navigation planning, such as estimating a time for a user to reach its destination based on the current speed and location of the user. This process/call flow may be referred to as an “open loop” configuration because the positioning engine does not receive any feedback from the HLOS and the applications. In other words, the positioning engine just provides position estimates to another entity (e.g., the HLOS or an application) and the process/call flow is completed.

Aspects presented herein may improve the performance and accuracy of a positioning engine (PE) by configuring the positioning engine to receive feedback from a navigation application. For example, in one aspect of the present disclosure, a navigation application may feed its calculated navigation route information (e.g., the navigation route information 606) to a PE to aid the PE computing positioning estimations based on a KF process/algorithm. Then, these positioning estimations may be used by the navigation application for calculating future navigation route information or updating the navigation route information (e.g., for performing KF time update and KF measurement update associated with the KF process/algorithm). This process/call flow may continue to repeat between the PE and the navigation application to create a closed-loop configuration/solution. In some examples, for the KF time update, the navigation route information may serve as a more accurate dynamic model, and for the KF measurement update, the navigation route information may be used for measurement outlier detection (e.g., for detecting error measurements or measurements that exceed an error threshold).

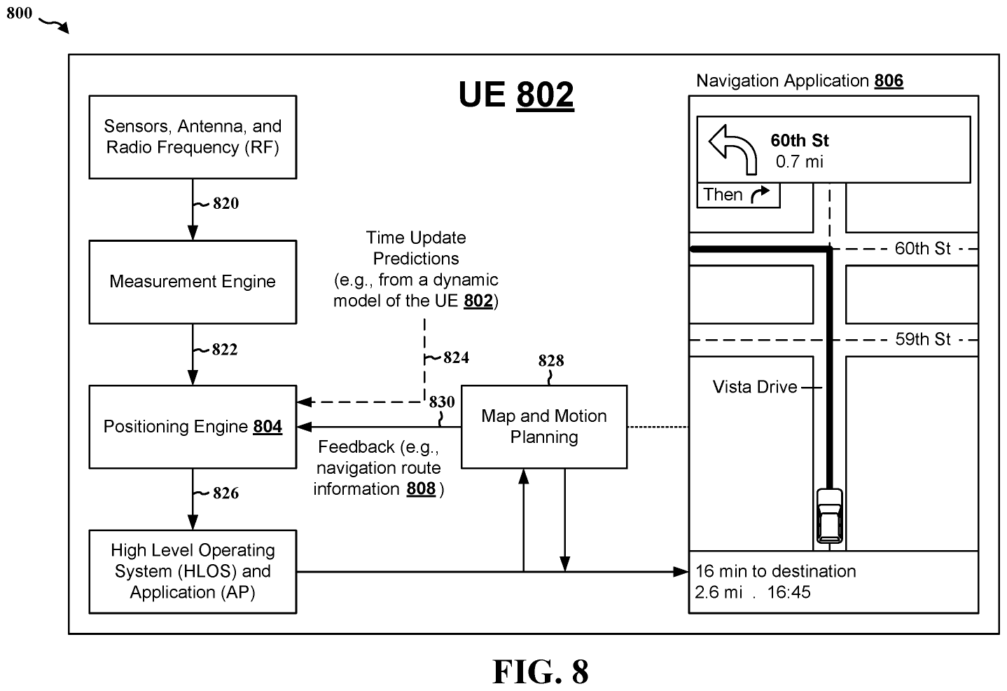

FIG. 8 is a diagram 800 illustrating an example close-loop configuration for a positioning engine and a navigation application in accordance with various aspects of the present disclosure. In one aspect, a UE 802 may include a plurality of function modules (which may also be referred to as “function logics” or simply “logics”) that is capable of performing positioning, calculating position estimates, generating navigation route information, and/or performing navigation. For example, the plurality of function modules may include at least a positioning engine module 804 and a navigation application module 806, etc.

In one example, when the UE 802 is configured/triggered to perform positioning (e.g., calculating/estimating its position), the UE 802 may first obtain a set of measurements that is specified for the positioning, such as via a measurement engine module. For example, as shown at 820, the UE 802 may measure its velocity, acceleration, altitude, and/or orientation using one or more sensors (e.g., IMU sensors, speed sensors, etc.), measure GNSS signals using its antenna(s), and/or perform radio frequency (RF) sensing using one or more sensing components.

As shown at 822, after the measurement engine module obtains the set of measurements specified for the positioning, the measurement engine module may pass the set of measurements to the positioning engine module 804. Then, the positioning engine module 804 may compute position estimates of the UE 802 (e.g., estimate the position of the UE 802) using a KF process/algorithm based on the set of measurement. In some examples, as shown at 824, the computation of the position estimates may further be based on a set of time update predictions, which may be generated by a dynamic model of the UE 802. For the KF process/algorithm, each position estimation may take two steps (i.e., time update prediction and measurement update correction). The time update prediction may come from a dynamic model of a UE. A dynamic model may refer to a model that can be trained online, where data is continually entering a system and the data is incorporated into the model through continuous updates. For example, a dynamic model (e.g., a simplest model) of the UE 802 may calculate the distance travelled by the UE 802 based on the travel time (e.g., a difference between the starting time and the ending time) and the velocity of the UE 802 (e.g., distance=delta_t*velocity). As such, this dynamic model of the UE (or the time update predictions from this dynamic model) may be used by the positioning engine module 804 (initially) for computing position estimates (e.g., for determining current position of the UE 802). Thus, in some examples, the KF time update model may be a dynamic model.

As shown at 826, a high-level operating system and/or one or more applications may use the position estimates from the positioning engine module 804 to perform other functions. For example, as shown at 828, the navigation application module 806 may use the position estimates from the positioning engine module 804 to calculate a navigation route from the current estimated position of the UE 802 to a destination (e.g., to generate real-time navigation route information 808). As described in connection with FIG. 6, the navigation route information 808 may include estimated positions \vec{r}(t) and velocities \vec{v}(t) of the UE 802 relative/respect to time (e.g., at different times). In some examples, the calculation of the navigation route may further be based on available map data/information, the destination, the navigation route type (e.g., cars, bikes, pedestrian walking, public transportation, etc.), the real-time traffic information, local traffic rules (e.g., speed limits, street directions, etc.), real-time crowdsourcing information (e.g., traffic condition, road construction, temporarily detour sign, speed limit change, etc. reported by a plurality of users in real-time or within a period of time), or a combination thereof.

In one aspect of the present disclosure, to improve the performance and accuracy of the positioning engine module 804, as shown at 830, the navigation application module 806 may feed its navigation route information 808 to the positioning engine module 804. The navigation route information 808 may be used for aiding the positioning engine module 804, such as the computation of position estimates based on the KF process/algorithm. In other words, the UE 802 or the positioning engine module 804 may change or verify positioning estimations performed by the positioning engine module 804 based on the navigation route information 808. For example, the navigation route information may be used to change, modify, or upgrade the dynamic model of the UE 802. For example, the initial dynamic model of the UE 802 may calculate the distance travelled based on travelled time and velocity. If the navigation route information 808 is available, this dynamic model may be modified/upgraded to use additional information to calculate the distance travelled, such as also considering the acceleration and direction of the UE 802. In other words, the navigation route information may serve as a more accurate dynamic model.

Then, the positioning engine module 806 may receive another set of measurement specified for computing the position estimates from the measurement engine module, and the positioning engine module 806 may estimate the current position of the UE 802 based on the new set of measurement and the navigation route information 808 (which may be used for performing time update and measurement update associated with the KF process/algorithm in the positioning engine module 804). Similarly, the navigation application module 806 may use the current estimated position of the UE 802 to continue performing the navigation, generating/updating/modifying the navigation route information 808, and feeding the navigation route information 808 (e.g., the real-time navigation route information) to the positioning engine module 804. This process may continue and repeat, thereby forming a close-loop configuration between the positioning engine module 804 and the navigation application module 806.

In one aspect, when the user of the UE 802 is following the navigation route planned/generated by the navigation application module 806 to make next move (e.g., to continue driving or perform turns, etc.), the navigation route information 808 may be used as a more robust KF time update model. For example, as described in connection with FIG. 6, certain navigation systems may be configured with high uncertainty values (e.g., +/−10 meters), such that they may not be able to detect subtle movement (e.g., a vehicle changing to an adjacent lane). However, by enabling the navigation route information 808 to be used for performing the KF time update, the UE 802 may be able to detect a more subtle movement (e.g., a pedestrian walking to another side of the street) because more information may be used by the KF of the positioning engine module 806 for KF time update.

In one example, the close-loop configuration described herein (e.g., using navigation route information 808 for KF time update) may be suitable for a KF with low measurement update rate (e.g., with measurement update rate below an update threshold) and/or a KF with very few or no measurement update (e.g., the number of positioning measurements is below a number threshold), such as when the UE 802 is in a deep urban area or in a tunnel where GNSS signal is sporadic or unavailable. In another example, the close-loop configuration may also be suitable for a KF with a time update model that has low accuracy (e.g., with an accuracy level below an accuracy threshold) and/or suitable for highly dynamic scenarios, such as making a turn in a highway exit or an intersection, etc. (KF time update model without using navigation route information 808 may be less accurate).

In another example, to use the navigation route information 808 for the KF time update, the current position of the UE 802 may be specified to precisely reflect on the navigation route planned by the navigation application module 806. As such, in another aspect of the present disclosure, a map matching function/algorithm may be used by the UE 802 for verifying whether the current position of the UE 802 is reflected on the navigation route (with certain level of accuracy). Map matching may refer to a procedure that assigns geographical objects to locations on a digital map, such as mapping raw GPS locations to road segments on a road network in order to create an estimate of the route taken. In some examples, sensor fusion (e.g., using inputs from sensors) may also be used for verifying whether the current position of the UE 802 is reflected on the navigation route, or for determining the uncertainty of KF time update model. For example, images captured by a UE may be used for verifying whether the UE is at a specified place (e.g., at an intersection, on a highway, etc.).

In some scenarios, when the closed-loop configuration described herein is used on stable route applications (e.g., public transportation systems like bus, railway, etc.), the assumptions that the user is following the planned navigation route and the current position of the UE is accurately reflected on the planned navigation route are more likely to be more solid. For autonomous driving scenarios, the navigation route information 808 (or the motion planning associated with autonomous driving) may also include real-time control from the vehicle. Then, the KF time update may rely more on real-time navigation route information 808 and/or the motion planning data. For some scenarios, the feedback navigation route information 808 may just include \vec{r}(t) and \vec{v}(t) from the navigation application module 806's motion planer.

In another aspect of the present disclosure, the navigation route information 808 may also be used by the positioning engine module 804 for measurement outlier detection (e.g., for detecting error measurements, measurements with errors exceeding an error threshold, etc.). Thus, instead of directly manipulating/updating the KF time update model, a secondary KF time update state may be used to do a more accurate measurement outliner detection. For example, the navigation route information 808 may be used for verifying whether measurements from the measurement engine module and/or position estimates computed by the positioning engine module 804. For example, the navigation route information 808 may indicate that at a specified point in time, the UE 802 is expected to be at a specified location with an estimated velocity, such as described in connection with FIG. 6. However, if at the specified point in time, the measurement engine module is providing a velocity measurement that is quite different from the estimated velocity (e.g., exceeding a difference threshold) and/or the position of the UE 802 estimated by the positioning engine module 804 exceeds a distance threshold, the UE 802 may perform additional measurement or using additional sensors to verify whether measurements from the measurement engine module and/or inputs to the positioning engine module 804 are accurate or include error(s).

In some examples, using the navigation route information 808 for measurement outlier detection may be suitable for pre-fit receiver autonomous integrity monitoring (RAIM), post-fit RAIM, and/or integer ambiguity resolution (IAR) (e.g., least-squares (LS) ambiguity decorrelation adjustment (LAMBDA)) validation process. RAIM may refer to a technology that is developed to assess the integrity of global positioning system (GPS) signals in a GPS receiver system. It may be important for safety-critical GPS applications, such as in aviation or marine navigation. For example, a GPS system may not include any internal information about the integrity of its signals. It is possible for a GPS satellite to broadcast slightly incorrect information that may cause navigation information to be incorrect, but a GPS receiver may not be able to detect the incorrect information. RAIM uses redundant signals to produce several GPS position fixes and compare them, and a statistical function determines whether a fault can be associated with any of the signals.

In some scenarios, when low-confident positioning solution is being generated (e.g., high horizontal estimated position error (HEPE), high dilution of precision (DOP), etc.), the UE 802 (or the positioning engine module 804) may use map matching and motion planning (e.g., the navigation route information 808) to perform measurement outliner detection instead of using the predicted state from KF time update. For purposes of the present disclosure, a solution may refer to a set of parameters associated with a KF or a KF state. For example, a set of parameters associated with a KF or KF state may include position, velocity, receiver clock, receiver clock rate, inter-satellite-type bias (ISTB), and/or ambiguity terms, etc.

In another example, if the UE 802 is performing dead reckoning (DR) using one or more IMU sensors, the navigation route information 808 may be used to calibrate the bias of the one or more IMU sensors. In navigation, DR may refer to a process of calculating current position of a moving object (e.g., the UE 802) by using a previously determined position, or fix, and then incorporating estimates of speed, heading direction, and course over elapsed time, which may be measured or obtained via sensors (e.g., IMU, camera, inertia sensor, speed and velocity sensor, etc.). For example, by knowing the estimated direction, velocity, and/or acceleration of the UE 802 at a specific point in time, the UE 802 may perform sensor calibration at that point in time. Sensor calibration may refer to an adjustment or set of adjustments performed on a sensor or instrument to make that instrument function as accurately, or error-free, as possible.

In another example, when camera and computer vision is involved, the navigation route information 808 (e.g., real-time navigation solution) may be used to cross-check with real-time feature(s) captured by the camera. Corresponding feedback may be used for optimizing the weighting between different sensors. For example, based on the navigation route information 808, the UE 802 may determine features capture by its front camera or a first sensor is more accurate than features captured by its rear camera or a second sensor. As such, the UE 802 may give more weight to the features captured by the front camera or the first sensor.

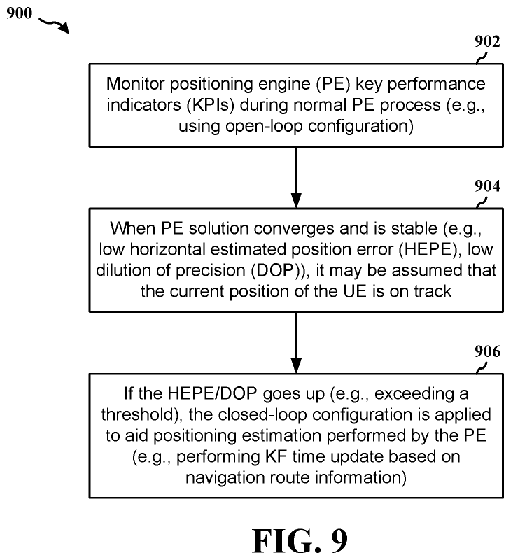

FIG. 9 is a flowchart 900 illustrating an example algorithm that enables a UE to switch between the open-loop configuration and the closed-loop configuration in accordance with various aspects of the present disclosure.

At 902, a UE (e.g., the UE 802) may monitor key performance indicators (KPIs) of its PE (e.g., the positioning engine module 804), such as HEPE, DOP, and/or measurement number, etc., during a normal PE process (e.g., during an open-loop configuration where the navigation application does not feedback information to the PE).

At 904, once the PE solution converges and is stable (e.g., low HEPE, low DOP, etc.), with additional validation, it may be assumed that the current position of the UE is on track with the navigation route planning from a navigation application (e.g., the navigation application module 806). The UE may continue to perform positioning and navigation based on the open-loop configuration.

At 906, if the monitored KPIs exceed certain threshold(s) (e.g., the HEPE/DOP goes up and exceeds an error threshold), the UE may switch to the closed-loop configuration where the navigation application may feed is navigation route information (e.g., the navigation route information 808) to the PE, thereby enabling the PE to engage additional dynamic model in KF time update to aid positioning estimation, such as described in connection with FIG. 8. If the monitored KPIs fall below the threshold(s) after a period of time, then the UE may again switch to the open-loop configuration.

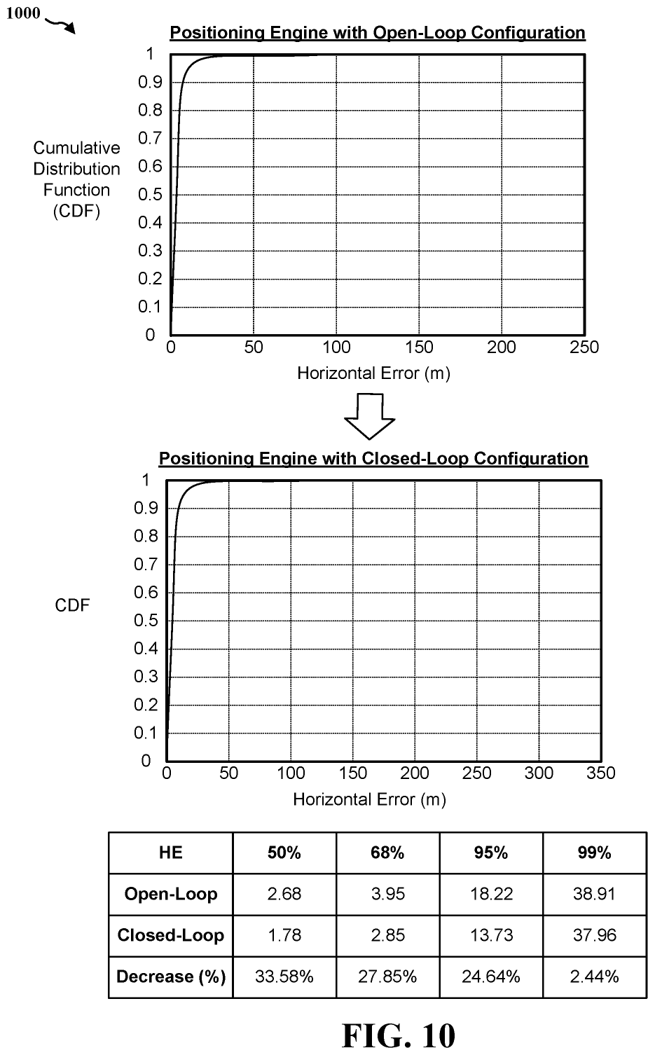

FIG. 10 is a diagram 1000 illustrating an example accuracy comparison between the open-loop configuration and the closed-loop configuration in accordance with various aspects of the present disclosure. As shown by the diagram, the horizontal position accuracy may be largely improved when the positioning engine is configured to perform the closed-loop configuration compared to the open-loop configuration.

In another aspect of the present disclosure, feeding navigation route information to the positioning engine may also be used for identifying incorrect map matching. In some scenarios, map matching solution may place the current position of a UE (e.g., the UE 802) on a wrong road. For example, at a traffic/highway exit, by verifying real-time navigation route information with KF dynamic state, the UE or a navigation application may detect potential wrong lane determination.

In another aspect of the present disclosure, a UE (e.g., the UE 802) may further be configured to verify the validity of the navigation route information (e.g., the navigation route information 808) provided by the navigation application (e.g., the navigation application module 806) based on sensor(s). For example, for vehicle-related applications/solutions, the camera of the vehicle may be a great sensor to verify the navigation route information. For instance, at the traffic exit locations, the camera and/or the computer vision of the vehicle may be used to verify whether the vehicle takes the exit or not. If the vehicle does not take the exit as planned by the navigation application, it may indicate that the navigation route information is no longer accurate (e.g., for a period of time until new/updated navigation route information is generated). In another example, for smartphones, motion sensors of a smartphone (e.g., IMU sensors) may be used to determine the motion pattern of the smartphone (or its user). This may assist the smartphone or the navigation application to determine whether the current navigation mode (e.g., travel by car, train, or bicycle, etc.) is valid or not. For example, the navigation application of the smartphone may generate the navigation route information based on assuming that the smartphone is on a vehicle. If sensors of the smartphone detect that the smartphone is on a bicycle (e.g., based on the movement of its user), the smartphone may determine that the navigation route information is invalid and not suitable for feeding to the positioning engine).

In another example, for stable route scenarios (e.g., on a train), there may be a benefit of identifying the modality transition points and changing the weighting used by the PE from different sensors. For example, if a UE is on a train, it may be configured to be on a sensing modality. However, when the UE gets off the train (especially if it is an underground scenario), then the PE of the UE may be configured to switch to dead reckoning. If the sensing result determines that the UE is on a train, then the PE may put much higher weight on the navigation route information, which may be obtained from the train network. In other words, the UE may use its sensor(s) to determine whether to apply the closed-loop configuration.

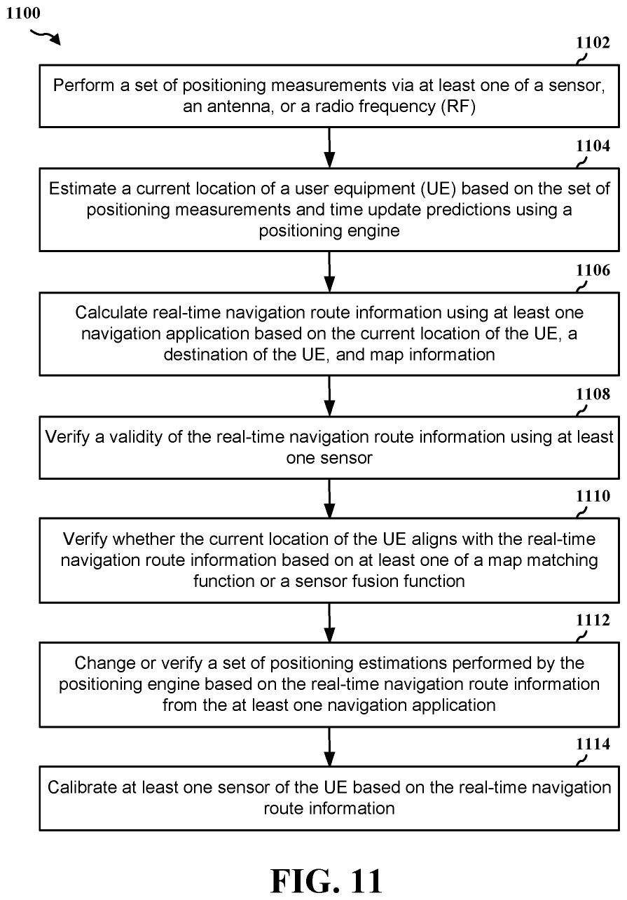

FIG. 11 is a flowchart 1100 of a method of wireless communication. The method may be performed by a UE (e.g., the UE 104, 404, 802; the GNSS device 506; the rover device 604; the apparatus 1304). The method may enable a navigation application of the UE to feed its calculated navigation route information to a PE of the UE to aid the PE computing positioning estimations based on a KF process/algorithm. Then, these positioning estimations may be used by the navigation application for calculating future navigation route information or updating the navigation route information, thereby improving the performance and accuracy of the positioning.

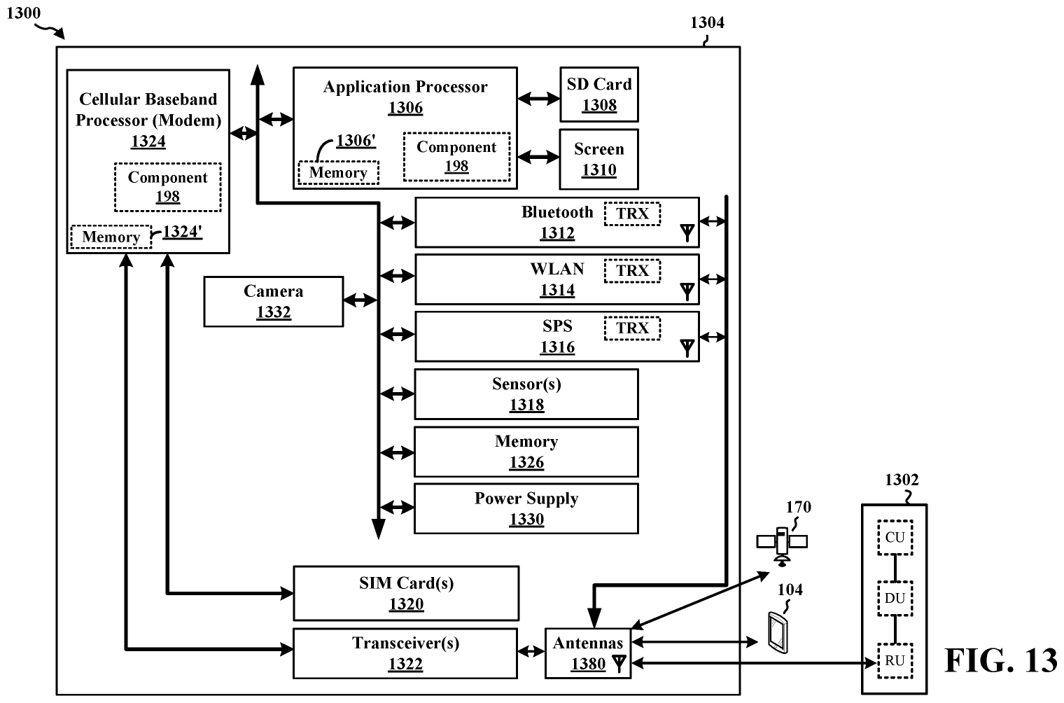

At 1104, the UE may estimate a current location of the UE based on a set of positioning measurements and time update predictions using a positioning engine, such as described in connection with FIG. 8. For example, at 822, the positioning engine module 804 may compute position estimates of the UE 802 (e.g., estimate the position of the UE 802) using a KF process/algorithm based on the set of measurement. In some examples, as shown at 824, the computation of the position estimates may further be based on a set of time update predictions, which may be generated by a dynamic model of the UE 802. The estimation of the current location of the UE may be performed by, e.g., the navigation component 198, the application processor 1306, the cellular baseband processor 1324, and/or the transceiver(s) 1322 of the apparatus 1304 in FIG. 13.

At 1106, the UE may calculate real-time navigation route information using at least one navigation application based on the current location of the UE, a destination of the UE, and map information, such as described in connection with FIG. 8. For example, at 828, the navigation application module 806 may use the position estimates from the positioning engine module 804 to calculate a navigation route from the current estimated position of the UE 802 to a destination. In some examples, the calculation of the navigation route may further be based on available map data/information. The calculation of the real-time navigation route information using at least one navigation application may be performed by, e.g., the navigation component 198, the application processor 1306, the cellular baseband processor 1324, and/or the transceiver(s) 1322 of the apparatus 1304 in FIG. 13.

In one example, the real-time navigation route information may include at least a set of estimated future positions and velocities of the UE with respect to time.

In another example, the real-time navigation route information may be calculated further based on real-time crowdsourcing information.

In another example, the real-time navigation route information is calculated further based on a navigation route type.

At 1112, the UE may change or verify a set of positioning estimations performed by the positioning engine based on the real-time navigation route information from the at least one navigation application, such as described in connection with FIG. 8. For example, at 830, the navigation application module 806 may feed its navigation route information 808 to the positioning engine module 804. The UE 802 or the positioning engine module 804 may change or verify positioning estimations performed by the positioning engine module 804 based on the navigation route information 808. The changing or verification of the set of positioning estimations performed by the positioning engine may be performed by, e.g., the navigation component 198, the application processor 1306, the cellular baseband processor 1324, and/or the transceiver(s) 1322 of the apparatus 1304 in FIG. 13.

In one example, to change or verify the set of positioning estimations performed by the positioning engine based on the real-time navigation route information, the UE may perform the set of positioning estimations via the positioning engine based on a KF process, and the UE may change a KF time update model associated with the KF process or verify whether there is a measurement error associated with the KF process based on the real-time navigation route information. In such an example, the KF process has a measurement update rate below an update threshold, the KF process includes a number of positioning measurements below a number threshold, or the KF process is associated with a time update model including an accuracy level below an accuracy threshold.

In another example, at 1102, the UE may perform a set of positioning measurements via at least one of a sensor, an antenna, or an RF, such as described in connection with FIG. 8. For example, at 820, the UE 802 may measure its velocity, acceleration, altitude, and/or orientation using one or more sensors (e.g., IMU sensors, speed sensors, etc.), measure GNSS signals using its antenna(s), and/or perform RF sensing using one or more sensing components. The set of positioning measurements may be performed by, e.g., the navigation component 198, the application processor 1306, the cellular baseband processor 1324, and/or the transceiver(s) 1322 of the apparatus 1304 in FIG. 13.

In another example, at 1108, the UE may verify a validity of the real-time navigation route information using at least one sensor, such as described in connection with FIG. 8. For example, for vehicle-related applications/solutions, the camera of the vehicle may be a great sensor to verify the navigation route information. The verification of the real-time navigation route information may be performed by, e.g., the navigation component 198, the application processor 1306, the cellular baseband processor 1324, and/or the transceiver(s) 1322 of the apparatus 1304 in FIG. 13. In some implementations, the UE may verify whether at least one feature captured by a camera of the UE is associated with an error based on the real-time navigation route information, such as described in connection with FIG. 8. For example, when camera and computer vision is involved, the navigation route information 808 (e.g., real-time navigation solution) may be used to cross-check with real-time feature(s) captured by the camera. The verification of whether at least one feature captured by a camera of the UE is associated with an error may be performed by, e.g., the navigation component 198, the application processor 1306, the cellular baseband processor 1324, and/or the transceiver(s) 1322 of the apparatus 1304 in FIG. 13.

In another example, at 1110, the UE may verify whether the current location of the UE aligns with the real-time navigation route information based on at least one of a map matching function or a sensor fusion function, such as described in connection with FIG. 8. For example, to use the navigation route information 808 for the KF time update, the current position of the UE 802 may be specified to precisely reflect on the navigation route planned by the navigation application module 806. As such, a map matching function/algorithm may be used by the UE 802 for verifying whether the current position of the UE 802 is reflected on the navigation route (with certain level of accuracy). The verification of whether the current location of the UE aligns with the real-time navigation route information may be performed by, e.g., the navigation component 198, the application processor 1306, the cellular baseband processor 1324, and/or the transceiver(s) 1322 of the apparatus 1304 in FIG. 13. In such an example, the UE may refrain from changing or verifying the set of positioning estimations performed by the positioning engine based on the real-time navigation route information if the current location of the UE does not align with the real-time navigation route information.

In another example, at 1114, the UE may calibrate at least one sensor of the UE based on the real-time navigation route information, such as described in connection with FIG. 8. For example, if the UE 802 is performing dead reckoning using one or more IMU sensors, the navigation route information 808 may be used to calibrate the bias of the one or more IMU sensors. The calibration of the at least one sensor of the UE may be performed by, e.g., the navigation component 198, the application processor 1306, the cellular baseband processor 1324, and/or the transceiver(s) 1322 of the apparatus 1304 in FIG. 13.

In another example, the UE may monitor a set of KPIs associated with the positioning engine, where to change or verify the set of positioning estimations performed by the positioning engine, the UE may change or verify the set of positioning estimations performed by the positioning engine based on the set of KPIs exceeding a threshold.

In another example, the UE may estimate a new location of the UE based on the changed or verified set of positioning estimations performed by the positioning engine, and the UE may update the real-time navigation route information based on the new location of the UE.

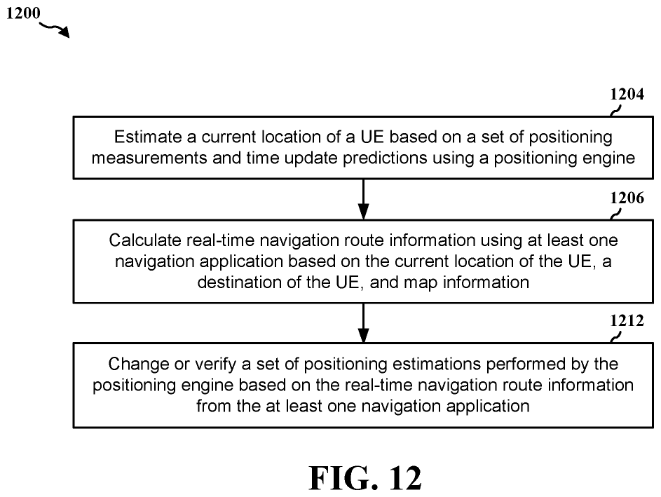

FIG. 12 is a flowchart 1200 of a method of wireless communication. The method may be performed by a UE (e.g., the UE 104, 404, 802; the GNSS device 506; the rover device 604; the apparatus 1304). The method may enable a navigation application of the UE to feed its calculated navigation route information to a PE of the UE to aid the PE computing positioning estimations based on a KF process/algorithm. Then, these positioning estimations may be used by the navigation application for calculating future navigation route information or updating the navigation route information, thereby improving the performance and accuracy of the positioning.

At 1204, the UE may estimate a current location of the UE based on a set of positioning measurements and time update predictions using a positioning engine, such as described in connection with FIG. 8. For example, at 822, the positioning engine module 804 may compute position estimates of the UE 802 (e.g., estimate the position of the UE 802) using a KF process/algorithm based on the set of measurement. In some examples, as shown at 824, the computation of the position estimates may further be based on a set of time update predictions, which may be generated by a dynamic model of the UE 802. The estimation of the current location of the UE may be performed by, e.g., the navigation component 198, the application processor 1306, the cellular baseband processor 1324, and/or the transceiver(s) 1322 of the apparatus 1304 in FIG. 13.

At 1206, the UE may calculate real-time navigation route information using at least one navigation application based on the current location of the UE, a destination of the UE, and map information, such as described in connection with FIG. 8. For example, at 828, the navigation application module 806 may use the position estimates from the positioning engine module 804 to calculate a navigation route from the current estimated position of the UE 802 to a destination. In some examples, the calculation of the navigation route may further be based on available map data/information. The calculation of the real-time navigation route information using at least one navigation application may be performed by, e.g., the navigation component 198, the application processor 1306, the cellular baseband processor 1324, and/or the transceiver(s) 1322 of the apparatus 1304 in FIG. 13.

In one example, the real-time navigation route information may include at least a set of estimated future positions and velocities of the UE with respect to time.

In another example, the real-time navigation route information may be calculated further based on real-time crowdsourcing information.

In another example, the real-time navigation route information is calculated further based on a navigation route type.

At 1212, the UE may change or verify a set of positioning estimations performed by the positioning engine based on the real-time navigation route information from the at least one navigation application, such as described in connection with FIG. 8. For example, at 830, the navigation application module 806 may feed its navigation route information 808 to the positioning engine module 804. The UE 802 or the positioning engine module 804 may change or verify positioning estimations performed by the positioning engine module 804 based on the navigation route information 808. The changing or verification of the set of positioning estimations performed by the positioning engine may be performed by, e.g., the navigation component 198, the application processor 1306, the cellular baseband processor 1324, and/or the transceiver(s) 1322 of the apparatus 1304 in FIG. 13.

In one example, to change or verify the set of positioning estimations performed by the positioning engine based on the real-time navigation route information, the UE may perform the set of positioning estimations via the positioning engine based on a KF process, and the UE may change a KF time update model associated with the KF process or verify whether there is a measurement error associated with the KF process based on the real-time navigation route information. In such an example, the KF process has a measurement update rate below an update threshold, the KF process includes a number of positioning measurements below a number threshold, or the KF process is associated with a time update model including an accuracy level below an accuracy threshold.

In another example, the UE may perform a set of positioning measurements via at least one of a sensor, an antenna, or an RF, such as described in connection with FIG. 8. For example, at 820, the UE 802 may measure its velocity, acceleration, altitude, and/or orientation using one or more sensors (e.g., IMU sensors, speed sensors, etc.), measure GNSS signals using its antenna(s), and/or perform RF sensing using one or more sensing components. The set of positioning measurements may be performed by, e.g., the navigation component 198, the application processor 1306, the cellular baseband processor 1324, and/or the transceiver(s) 1322 of the apparatus 1304 in FIG. 13.

In another example, the UE may verify a validity of the real-time navigation route information using at least one sensor, such as described in connection with FIG. 8. For example, for vehicle-related applications/solutions, the camera of the vehicle may be a great sensor to verify the navigation route information. The verification of the real-time navigation route information may be performed by, e.g., the navigation component 198, the application processor 1306, the cellular baseband processor 1324, and/or the transceiver(s) 1322 of the apparatus 1304 in FIG. 13. In some implementations, the UE may verify whether at least one feature captured by a camera of the UE is associated with an error based on the real-time navigation route information, such as described in connection with FIG. 8. For example, when camera and computer vision is involved, the navigation route information 808 (e.g., real-time navigation solution) may be used to cross-check with real-time feature(s) captured by the camera. The verification of whether at least one feature captured by a camera of the UE is associated with an error may be performed by, e.g., the navigation component 198, the application processor 1306, the cellular baseband processor 1324, and/or the transceiver(s) 1322 of the apparatus 1304 in FIG. 13.

In another example, the UE may verify whether the current location of the UE aligns with the real-time navigation route information based on at least one of a map matching function or a sensor fusion function, such as described in connection with FIG. 8. For example, to use the navigation route information 808 for the KF time update, the current position of the UE 802 may be specified to precisely reflect on the navigation route planned by the navigation application module 806. As such, a map matching function/algorithm may be used by the UE 802 for verifying whether the current position of the UE 802 is reflected on the navigation route (with certain level of accuracy). The verification of whether the current location of the UE aligns with the real-time navigation route information may be performed by, e.g., the navigation component 198, the application processor 1306, the cellular baseband processor 1324, and/or the transceiver(s) 1322 of the apparatus 1304 in FIG. 13. In such an example, the UE may refrain from changing or verifying the set of positioning estimations performed by the positioning engine based on the real-time navigation route information if the current location of the UE does not align with the real-time navigation route information.

In another example, the UE may calibrate at least one sensor of the UE based on the real-time navigation route information, such as described in connection with FIG. 8. For example, if the UE 802 is performing dead reckoning using one or more IMU sensors, the navigation route information 808 may be used to calibrate the bias of the one or more IMU sensors. The calibration of the at least one sensor of the UE may be performed by, e.g., the navigation component 198, the application processor 1306, the cellular baseband processor 1324, and/or the transceiver(s) 1322 of the apparatus 1304 in FIG. 13.

In another example, the UE may monitor a set of KPIs associated with the positioning engine, where to change or verify the set of positioning estimations performed by the positioning engine, the UE may change or verify the set of positioning estimations performed by the positioning engine based on the set of KPIs exceeding a threshold.

In another example, the UE may estimate a new location of the UE based on the changed or verified set of positioning estimations performed by the positioning engine, and the UE may update the real-time navigation route information based on the new location of the UE.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′,1306′, respectively. The additional memory modules 1326 may also be considered a computer-readable medium/memory. Each computer-readable medium/memory 1324′,1306′,1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see 350 of FIG. 3) and include the additional modules of the apparatus 1304.

As discussed supra, the navigation component 198 is configured to estimate a current location of the UE based on a set of positioning measurements and time update predictions using a positioning engine. The navigation component 198 may also be configured to calculate real-time navigation route information using at least one navigation application based on the current location of the UE, a destination of the UE, and map information. The navigation component 198 may also be configured to change or verify a set of positioning estimations performed by the positioning engine based on the real-time navigation route information from the at least one navigation application. The navigation component 198 may be within the cellular baseband processor 1324, the application processor 1306, or both the cellular baseband processor 1324 and the application processor 1306. The navigation component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, includes means for estimating a current location of the UE based on a set of positioning measurements and time update predictions using a positioning engine. The apparatus 1304 may further include means for calculating real-time navigation route information using at least one navigation application based on the current location of the UE, a destination of the UE, and map information. The apparatus 1304 may further include means for changing or means for verifying a set of positioning estimations performed by the positioning engine based on the real-time navigation route information from the at least one navigation application.

In one configuration, the real-time navigation route information may include at least a set of estimated future positions and velocities of the UE with respect to time.

In another configuration, the real-time navigation route information may be calculated further based on real-time crowdsourcing information.

In another configuration, the real-time navigation route information is calculated further based on a navigation route type.

In another configuration, the means for changing or verifying the set of positioning estimations performed by the positioning engine based on the real-time navigation route information include configuring the apparatus 1304 to perform the set of positioning estimations via the positioning engine based on a KF process, and change a KF time update model associated with the KF process or verify whether there is a measurement error associated with the KF process based on the real-time navigation route information. In such a configuration, the KF process has a measurement update rate below an update threshold, the KF process includes a number of positioning measurements below a number threshold, or the KF process is associated with a time update model including an accuracy level below an accuracy threshold.

In another configuration, the apparatus 1304 may further include means for performing a set of positioning measurements via at least one of a sensor, an antenna, or an RF.

In another configuration, the apparatus 1304 may further include means for verifying a validity of the real-time navigation route information using at least one sensor.

In another configuration, the apparatus 1304 may further include means for verifying whether the current location of the UE aligns with the real-time navigation route information based on at least one of a map matching function or a sensor fusion function. In such a configuration, the apparatus 1304 may further include means for refraining from changing or verifying the set of positioning estimations performed by the positioning engine based on the real-time navigation route information if the current location of the UE does not align with the real-time navigation route information.

In another configuration, the apparatus 1304 may further include means for calibrating at least one sensor of the UE based on the real-time navigation route information.

In another configuration, the apparatus 1304 may further include means for verifying whether at least one feature captured by a camera of the UE is associated with an error based on the real-time navigation route information.

In another configuration, the apparatus 1304 may further include means for monitoring a set of KPIs associated with the positioning engine, where the means for changing or verifying the set of positioning estimations performed by the positioning engine include configuring the apparatus 1304 to change or verify the set of positioning estimations performed by the positioning engine based on the set of KPIs exceeding a threshold.

In another configuration, the apparatus 1304 may further include means for estimating a new location of the UE based on the changed or verified set of positioning estimations performed by the positioning engine, and means for updating the real-time navigation route information based on the new location of the UE.

The means may be the navigation component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: estimating a current location of the UE based on a set of positioning measurements and time update predictions using a positioning engine; calculating real-time navigation route information using at least one navigation application based on the current location of the UE, a destination of the UE, and map information; and changing or verifying a set of positioning estimations performed by the positioning engine based on the real-time navigation route information from the at least one navigation application.

Aspect 2 is the method of aspect 1, further including: performing the set of positioning measurements via at least one of a sensor, an antenna, or a radio frequency.

Aspect 3 is the method of aspect 1 or 2, where the real-time navigation route information includes at least a set of estimated future positions and velocities of the UE with respect to time.

Aspect 4 is the method of any of aspects 1 to 3, where changing or verifying the set of positioning estimations performed by the positioning engine based on the real-time navigation route information includes: performing the set of positioning estimations via the positioning engine based on a KF process; and changing a KF time update model associated with the KF process or verifying whether there is a measurement error associated with the KF process based on the real-time navigation route information.

Aspect 5 is the method of aspect 4, where the KF process has a measurement update rate below an update threshold, the KF process includes a number of positioning measurements below a number threshold, or the KF process is associated with a time update model including an accuracy level below an accuracy threshold.

Aspect 6 is the method of any of aspects 1 to 5, further including: verifying a validity of the real-time navigation route information using at least one sensor.

Aspect 7 is the method of any of aspects 1 to 6, where the real-time navigation route information is calculated further based on real-time crowdsourcing information.

Aspect 8 is the method of any of aspects 1 to 7, further including: verifying whether the current location of the UE aligns with the real-time navigation route information based on at least one of a map matching function or a sensor fusion function.

Aspect 9 is the method of aspect 8, further including: refraining from changing or verifying the set of positioning estimations performed by the positioning engine based on the real-time navigation route information if the current location of the UE does not align with the real-time navigation route information.

Aspect 10 is the method of any of aspects 1 to 9, further including: calibrating at least one sensor of the UE based on the real-time navigation route information.

Aspect 11 is the method of any of aspects 1 to 10, further including: verifying whether at least one feature captured by a camera of the UE is associated with an error based on the real-time navigation route information.

Aspect 12 is the method of any of aspects 1 to 11, further including: monitoring a set of KPIs associated with the positioning engine; where changing or verifying the set of positioning estimations performed by the positioning engine includes: changing or verifying the set of positioning estimations performed by the positioning engine based on the set of KPIs exceeding a threshold.

Aspect 13 is the method of any of aspects 1 to 12, where the real-time navigation route information is calculated further based on a navigation route type.

Aspect 14 is the method of any of aspects 1 to 13, further including: estimating a new location of the UE based on the changed or verified set of positioning estimations performed by the positioning engine; and updating the real-time navigation route information based on the new location of the UE.

Aspect 15 is an apparatus for wireless communication at a UE, including: a memory; and at least one processor coupled to the memory and, based at least in part on information stored in the memory, the at least one processor is configured to implement any of aspects 1 to 14.

Aspect 16 is the apparatus of aspect 15, further including at least one of a transceiver or an antenna coupled to the at least one processor.

Aspect 17 is an apparatus for wireless communication including means for implementing any of aspects 1 to 14.

Aspect 18 is a computer-readable medium (e.g., a non-transitory computer-readable medium) storing computer executable code, where the code when executed by a processor causes the processor to implement any of aspects 1 to 14.

What is claimed is:

1. An apparatus for wireless communication at a user equipment (UE), comprising:
a memory; and
at least one processor coupled to the memory and, based at least in part on second information stored in the memory, the at least one processor is configured to:
estimate a current location of the UE based on a set of positioning measurements and time update predictions using a positioning engine;
calculate real-time navigation route information using at least one navigation application based on the current location of the UE, a destination of the UE, and map information; and
change or verify a set of positioning estimations performed by the positioning engine based on the real-time navigation route information from the at least one navigation application.

2. The apparatus of claim 1, wherein the at least one processor is further configured to:
perform the set of positioning measurements via at least one of a sensor, an antenna, or a radio frequency (RF).

3. The apparatus of claim 1, wherein the real-time navigation route information includes at least a set of estimated future positions and velocities of the UE with respect to time.

4. The apparatus of claim 1, wherein to change or verify the set of positioning estimations performed by the positioning engine based on the real-time navigation route information, the at least one processor is configured to:
perform the set of positioning estimations via the positioning engine based on a Kalman filter (KF) process; and
change a KF time update model associated with the KF process or verify whether there is a measurement error associated with the KF process based on the real-time navigation route information.

5. The apparatus of claim 4, wherein the KF process has a measurement update rate below an update threshold, the KF process includes a number of positioning measurements below a number threshold, or the KF process is associated with a time update model including an accuracy level below an accuracy threshold.

6. The apparatus of claim 1, wherein the at least one processor is further configured to:
verify a validity of the real-time navigation route information using at least one sensor.

7. The apparatus of claim 1, wherein to calculate the real-time navigation route information, the at least one processor is configured to calculate the real-time navigation route information further based on real-time crowdsourcing information.

8. The apparatus of claim 1, wherein the at least one processor is further configured to:
verify whether the current location of the UE aligns with the real-time navigation route information based on at least one of a map matching function or a sensor fusion function.

9. The apparatus of claim 8, wherein the at least one processor is further configured to:
refrain from changing or verifying the set of positioning estimations performed by the positioning engine based on the real-time navigation route information if the current location of the UE does not align with the real-time navigation route information.

10. The apparatus of claim 1, wherein the at least one processor is further configured to:
calibrate at least one sensor of the UE based on the real-time navigation route information.

11. The apparatus of claim 1, wherein the at least one processor is further configured to:
verify whether at least one feature captured by a camera of the UE is associated with an error based on the real-time navigation route information.

12. The apparatus of claim 1, wherein the at least one processor is further configured to:
monitor a set of key performance indicators (KPIs) associated with the positioning engine;
wherein to change or verify the set of positioning estimations performed by the positioning engine, the at least one processor is configured to change or verify the set of positioning estimations performed by the positioning engine based on the set of KPIs exceeding a threshold.

13. The apparatus of claim 1, wherein the at least one processor is further configured to calculate the real-time navigation route information further based on a navigation route type.

14. The apparatus of claim 1, wherein the at least one processor is further configured to:
estimate a new location of the UE based on the changed or verified set of positioning estimations performed by the positioning engine; and
update the real-time navigation route information based on the new location of the UE.

15. A method of wireless communication at a user equipment (UE), comprising:
estimating a current location of the UE based on a set of positioning measurements and time update predictions using a positioning engine;
calculating real-time navigation route information using at least one navigation application based on the current location of the UE, a destination of the UE, and map information; and
changing or verifying a set of positioning estimations performed by the positioning engine based on the real-time navigation route information from the at least one navigation application.

16. The method of claim 15, further comprising:
performing the set of positioning measurements via at least one of a sensor, an antenna, or a radio frequency (RF).

17. The method of claim 15, wherein the real-time navigation route information includes at least a set of estimated future positions and velocities of the UE with respect to time.

18. The method of claim 15, wherein changing or verifying the set of positioning estimations performed by the positioning engine based on the real-time navigation route information comprises:
performing the set of positioning estimations via the positioning engine based on a Kalman filter (KF) process; and
changing a KF time update model associated with the KF process or verifying whether there is a measurement error associated with the KF process based on the real-time navigation route information.

19. The method of claim 18, wherein the KF process has a measurement update rate below an update threshold, the KF process includes a number of positioning measurements below a number threshold, or the KF process is associated with a time update model including an accuracy level below an accuracy threshold.

20. The method of claim 15, further comprising:
verifying a validity of the real-time navigation route information using at least one sensor.

21. The method of claim 15, wherein the real-time navigation route information is calculated further based on real-time crowdsourcing information.

22. The method of claim 15, further comprising:
verifying whether the current location of the UE aligns with the real-time navigation route information based on at least one of a map matching function or a sensor fusion function.

23. The method of claim 22, further comprising:
refraining from changing or verifying the set of positioning estimations performed by the positioning engine based on the real-time navigation route information if the current location of the UE does not align with the real-time navigation route information.

24. The method of claim 15, further comprising:
calibrating at least one sensor of the UE based on the real-time navigation route information.

25. The method of claim 15, further comprising:
verifying whether at least one feature captured by a camera of the UE is associated with an error based on the real-time navigation route information.

26. The method of claim 15, further comprising:
monitoring a set of key performance indicators (KPIs) associated with the positioning engine;
wherein changing or verifying the set of positioning estimations performed by the positioning engine comprises changing or verifying the set of positioning estimations performed by the positioning engine based on the set of KPIs exceeding a threshold.

27. The method of claim 15, wherein the real-time navigation route information is calculated further based on a navigation route type.

28. The method of claim 15, further comprising:
estimating a new location of the UE based on the changed or verified set of positioning estimations performed by the positioning engine; and
updating the real-time navigation route information based on the new location of the UE.

29. An apparatus for wireless communication at a user equipment (UE), comprising:
means for estimating a current location of the UE based on a set of positioning measurements and time update predictions using a positioning engine;
means for calculating real-time navigation route information using at least one navigation application based on the current location of the UE, a destination of the UE, and map information; and
means for changing or verifying a set of positioning estimations performed by the positioning engine based on the real-time navigation route information from the at least one navigation application.

30. A computer-readable medium storing computer executable code at a user equipment (UE), the code when executed by a processor causes the processor to:
estimate a current location of the UE based on a set of positioning measurements and time update predictions using a positioning engine;
calculate real-time navigation route information using at least one navigation application based on the current location of the UE, a destination of the UE, and map information; and
change or verify a set of positioning estimations performed by the positioning engine based on the real-time navigation route information from the at least one navigation application.
